(19) United States
(12) Patent Application Publication
(10) Pub. No.: US 2002/0129139 A1
(43) Pub. Date: Sep. 12, 2002

(54) System and method for facilitating the activities of remote workers

(76) Inventor: Subramanyan Ramesh, Hermosa Beach, CA (US)

Correspondence Address: STRADLING YOCCA CARLSON & RAUTH, IP Department, P.O. Box 7680, 660 Newport Center Drive, Suite 1600, Newport Beach, CA, 92660-6441, US

(21) Appl. No.: 09/948,178

(22) Filed: Sep. 5, 2001

Related U.S. Application Data
(60) Provisional application No. 60/230,584, filed on Sep. 5, 2000.

(51) Int. Cl. G06F 15/173

(52) U.S. Cl. 709/224; 709/205

(57) ABSTRACT

A method for facilitating remote working includes monitoring at least one parameter which is representative of the performance of at least one remote workers and using the monitored parameter(s) to determine the performance of the remote work(s) which are being monitored.

### PRIORITY CLAIM

This patent application claims the benefit of the filing date of U.S. provisional patent application serial No. 60/230,584, filed Sep. 5, 2000 and entitled SYSTEM AND METHOD OF FACILITATING THE ACTIVITIES OF REMOTE WORKERS, the entire contents of which are hereby expressly incorporated by reference.

### FIELD OF THE INVENTION

The present invention relates generally to enabling the better management of remote working. The present invention relates more particularly to a method for facilitating remote working or telecommuting, wherein the method comprises monitoring at least one parameter which is representative of the performance of at least one remote worker and determining the performance of the remote worker(s) at least partially by utilizing the monitored parameter(s).

### BACKGROUND OF THE INVENTION

Remote working occurs any time that one or more workers work on a task while in locations different from the central location for management of the task. This may occur when people from two offices from the same company collaborate on a task, or when people from different companies collaborate on a task, or when some employees telecommute for some period of time while performing the task.

Remote working from different remote offices is desirable because it allows workers who have the best skill set to work on a task, regardless of proximity. It allows companies to best use their human resources and leads to increased productivity.

Telecommuting is a well known alternative to actually being present at an onsite workplace (an office or other facility of an employer). Telecommuters perform at least some portion of their work duties at a remote location, i.e., a location different from the workplace. Typically, telecommuters perform at least some portion of their work duties at home.

Telecommuting is desirable because it reduces the employer's employee related expenses, such as those expenses commonly associated with procuring and maintaining onsite work space. That is, an employer can generally purchase or lease substantially less office space or other such facility when at least a portion of the employer's employees telecommute. As those skilled in the art will appreciate, a substantial reduction in the amount of office space required can result in a corresponding substantial reduction in employee related expenses, particularly in those areas where office space is expensive. The Canadian Telework Association (a non-profit organization dedicated to promoting telework, whose members include government organizations, universities and academic organizations, and major corporations such as IBM, AT&T) reports: “the numerous benefits from teleworking (1 day per week) <include>: saving some $2,000 of office space and related costs per telecommuter; increasing productivity by 20-30%; enhancing corporate recruitment and retention; improving access to untapped labor markets globally”

Additionally, telecommuting is desirable because it reduces traffic congestion, reduces the pollution associated with traveling to and from an onsite workplace, reduces the stress associated with such travel, and generally improves the moral of employees.

However, remote working and telecommuting is undesirable in that it makes the management of remote tasks, and the monitoring of the performance of employees more difficult. It is inherently more difficult to monitor the performance of employees when the employees are located remotely with respect to the work site and the supervisors of the employees. This inability to accurately monitor the performance of remote workers which has made many employees reluctant to take advantage of a remote working program. As might be expected, employers typically prefer to have some assurance that employees are providing an amount of work which is commensurate with their compensation. In addition, EcaTT (The Electronic Commerce and Telework Trends Project, an ongoing European Commission project) reports that managers are concerned about: data security problems; insufficient knowledge of [employee activity by]managers; and problems organizing communication”

Monitoring employees who work on site is generally a well understood and common place activity for supervisors. However, when a supervisor does not have direct access to a worker, e.g., the ability to see and speak with the worker, then monitoring the performance of a worker can be very difficult. Although it is possible to monitor the performance of a worker based upon the final work product of the worker, such monitoring requires that the work product be at least in some stage of completion. At this point, it may be to late to attempt to change the behavior of an ineffective worker or to replace that worker. Therefore, it is desirable to monitor the performance of workers on an on going basis, such that deficiencies in the performance of a worker can be addressed promptly and effectively.

In view of the foregoing, it is desirable to provide a system and method for facilitating the activities of remote workers which includes the capability for accurately monitoring the performance of remote workers so that employers are encouraged to implement and utilize remote working programs. It is also desirable to include within that system, a secure method of communications between all workers and their team members and managers, that encourages collaborations and communications between remote workers and their managers while keeping to the highest available security. It is also desirable to allow managers to get real time information and communications with their remote workers who are currently working. Finally it is desirable to enable this system on all types of communications, and information devices and any other types of devices which may currently be in existence or be developed that allow a worker to perform some part of a remote task, and that can communicate with a remote or local server, including but not limited to: personal computers, portable computers, information based hand held devices, portable phones including smart phones, cell phones and digital phones.

### SUMMARY OF THE INVENTION

The present invention specifically addresses and alleviates the above mentioned deficiencies associated with the prior art. More particularly, the present invention comprises a system and method for facilitating remote working which comprises monitoring at least one parameter which is representative of performance of at least one remote worker and determining performance of the remote worker(s) at least partially by the monitored parameter(s).

Thus, these as well as other advantages of the present invention will be more apparent from the following description and drawings. It is understood that changes in the specific structure shown and described may be made within in the scope of the claims without departing from the spirit of the invention.

### BRIEF DESCRIPTION OF THE DRAWINGS

FIG. 1 is a block diagram showing the system for facilitating remote working according to the present invention, implemented upon a network;

FIG. 2 is a flow chart showing the process of displaying a report according to the present invention;

FIG. 3 is a flow chart showing the process of adding users and changing permissions according to the present invention;

FIG. 4 is a flow chart showing the process of automatic notification according to the present invention;

FIG. 5 is a flow chart showing an overview of employee use of the system for facilitating remote working according to the present invention;

FIG. 6 is a flow chart showing the process of assigning tasks and task types; and

FIG. 7 is a flow chart showing the process of communicating with team members according to the present invention.

### DETAILED DESCRIPTION OF THE INVENTION

The detailed description set forth below in connection with the appended drawings is intended as a description of the presently preferred embodiment of the invention, and is not intended to represent the only form in which the present invention can be constructed or utilized. The detailed description sets forth the instruction and the functions of the invention, as well as the sequence of steps for operating the invention in connection with the illustrated embodiment. It is to be understood, however, that the same or equivalent functions may be accomplished by different embodiments that are also intended to be encompassed within the spirit and scope of the invention.

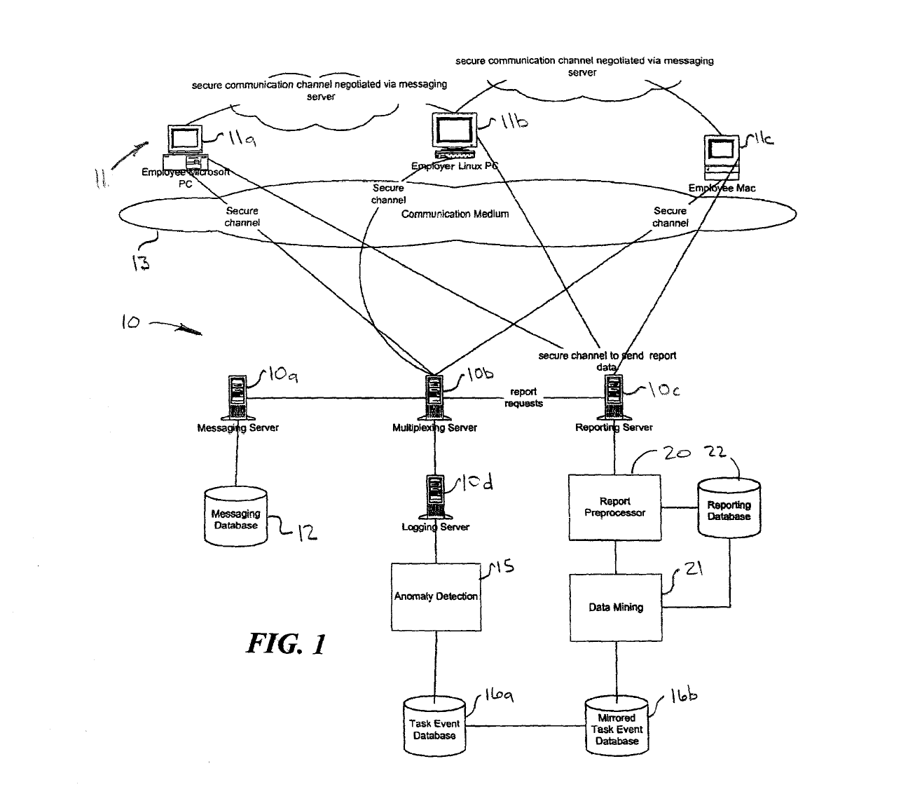

The system and method for facilitating the activities of remote workers of the present invention is illustrated in FIGS. 1 through 7, which are discussed in detail below and which depict a presently preferred embodiment thereof.

The present invention comprises a method for facilitating remote working, wherein the method comprises monitoring at least one parameter which is representative of the performance of at least one remote worker and determining the performance of the remote worker(s) at least partially by the monitored parameter(s). Typically a plurality of remote workers will be monitored and their performance will be determined. Typically, a plurality of monitored parameters will be utilized to determine the performance of each of the remote worker(s).

According to one aspect of the present invention, monitoring at least one parameter comprises monitoring at least one parameter over time. Monitoring at least one parameter over time facilitates the determination of the performance of the remote worker(s) by comparing the monitored parameter(s) of the remote worker(s) for one time period to the same monitored parameter(s) of the same remote worker(s) for at least one other time period. However, the present invention may be used to monitor the performance of any remote worker or group of remote workers over any desired time period and then compare the monitored parameters to the same or similar monitored parameters for the same workers or any other workers. That is, in order to determine the performance of any given remote worker(s), at least one parameter representative of the performance of the worker(s) can be compared to the same or similar parameters for the same any other remote worker(s) at any other time.

According to one aspect of the present invention, the performance of a remote worker is determined by comparing at least one monitored parameter of the remote worker for one time period to the same monitored parameter(s) of the same remote worker for at least one other time period. For example, the performance of a remote worker optionally comprises comparing present monitored parameter(s) of the remote worker to past monitored parameter(s) of the same remote worker. As those skilled in the art will appreciate, when a monitored parameter is monitored over a time period, the monitored parameter may be averaged over that time period and the average then used to determine performance. Similarly, a parameter may be monitored over a plurality of time period and the monitored parameter for each time periods may be utilized to determine an average of the monitored parameter for all of the time periods, taken together.

According to one aspect of the present invention, determining the performance of the remote worker(s) is at least partially performed by comparing monitored parameter(s) for one remote worker to monitored parameter(s) for at least one other remote worker.

According to another aspect of the present invention, determining the performance of the remote worker(s) at least partially by the monitored parameter(s) comprises comparing the monitored parameter(s) for one remote worker to the monitored parameter(s) for a plurality of other remote workers.

According to another aspect of the present invention, determining the performance of the remote worker(s) at least partially by the monitored parameter(s) comprises comparing the monitored parameter(s) for a group of remote workers to the monitored parameter(s) for another group of remote workers.

Thus, according to the present invention, the performance of either a single worker or a group of workers (such as the average performance for the group) may be compared to the performance of either a single worker or a group of workers (such as the average performance for the group). In this manner, the performance of either a single worker or a group of workers may readily be determined. For example, the performance of one worker may be compared to the performance of another worker; the performance of one worker may be compared to the performance of a group of workers; the performance of a group of workers may compared to the performance of one worker; or the performance of a group of workers may be compared to the performance another group of workers. Any desired combination of single worker and group of workers may thus serve as the basis for such comparison's.

Preferably, monitoring at least one parameter which is representative of performance of at least one remote worker comprises monitoring at least one parameter of a plurality of remote workers who are performing substantially the same tasks.

Optionally, monitoring at least one parameter comprises both monitoring at least one parameter of one remote worker over time and monitoring at least one parameter of a plurality of remote workers at the same time.

Determining the performance of the remote worker(s) optionally comprises both comparing the monitored parameter(s) of one worker to the monitored parameter(s) for the same worker over time and comparing the monitored parameter(s) of one worker to the monitored parameter(s) for other remote workers over time.

The monitored parameter(s) preferably comprise at least one of: time logged onto a computer or information device, task selected when logged on, activity during the selected tasks including: the number of keystrokes entered into a computer, time spent in an activity or a file, number of files opened, difference in file size as monitored at two different times, time spent in network activities, quantity of data transferred via a network, time during which no activity is detected, number of applications open, number of documents opened, the identity of the current window focus, the amount of time spent with focus in each windows, the amount and type of activity while in each window focus, any other parameter which may be derived from one or more operating system events, or any combination of these parameters

Determining the performance of the remote worker(s) optionally comprises comparing the monitored parameters to at least one predetermined standard. The predetermined standard optionally comprises at least one average of the monitored parameter(s). As mentioned above, the monitored parameter itself may comprise an average. Such averages (for either the remote worker being monitored or for calculation of the standard) may be taken either over time or among a group of remote workers or both over time and among a group of remote workers. Therefore determining the performance of the remote worker(s) optionally comprises comparing the monitored parameter(s) to at least one average of previous measurements of the parameter(s) taken among remote workers. Alternatively, determining the performance of the remote worker(s) comprises comparing the monitored parameter(s) to at least one average of present measurements of the parameter(s) taken among remote workers. Optionally, determining the performance of the remote worker(s) comprises comparing both the parameters to at least one average of present measurements of the parameter(s) taken among remote workers and also comprises comparing the monitored parameter(s) to at least one average of previous measurements of the parameter(s) taken among remote workers.

Preferably, the measured parameter(s) which are representative of performance comprise parameters which are representative of productivity. However, as those skilled in the art will appreciate, the parameters which are representative of performance may alternatively comprise any other desired parameter, such as those representative of quality.

Generally, the remote workers are located a substantial distance from a supervisor of the remote workers. Typically, the supervisor will be the person who reviews the monitored performance of the remote workers. Alternatively, the remote workers may be located proximate the supervisor or at any other desired location. Thus, in addition to facilitating the activities of remote workers, the present invention also facilitates the activities of on-site workers. Moreover, the present invention facilitates monitoring of the performance of workers, regardless of the location of the workers.

Generally, the remote workers are located a substantial distance from where determining performance of the remote worker(s) occurs. However, the remote worker(s) may be located at any desired location with respect to where determining performance of the remote worker(s) occurs.

Preferably, the system and method for facilitating the activities of remote workers of the present invention further comprises at least one of: facilitating text transfer between at least one remote worker and at least one other remote worker, facilitating text transfer between at least one remote worker and at least one non-remote worker, facilitating voice communication between at least one remote worker and at least one other remote worker; facilitating voice communication between at least one remote worker and at least one non-remote worker; facilitating on-line chat between at least one remote worker and at least one other remote worker; facilitating on-line chat between at least one remote worker and at least one non-remote worker, facilitating instant messaging between at least one remote worker and at least one other remote worker; facilitating instant messaging between at least one remote worker and at least one non-remote worker, facilitating file transfers between at least one remote worker and at least one remote worker, facilitating file transfers between at least one remote worker and at least one non-remote worker, facilitating collaborative work on a command document; facilitating collaborative work on multiple documents, facilitating collaborative work on a commonly distributed application, facilitating collaborative work on separate applications, and facilitating collaborative work by providing means of communication between different clients.

According to the present invention, a remote worker preferably permissions monitoring of at least one parameter which is representative of performance of the same remote worker. It is desirable that a remote worker permission monitoring of such parameter(s), since such permissioning provides a more comfortable, non-adversarial, environment within which the remote worker works. By allowing the remote worker to permission monitoring of the remote workers performance, the remote worker is complying with the system in a manner which encourages performance of the remote worker. That is, since the remote worker is well aware of such monitoring and since the remote worker has given permission for such monitoring, the remote worker is substantially more likely to be motivated to provide an average or superior work product.

The system and method for facilitating the activities of remote workers of the present invention preferably further comprises the ability to identify bottlenecks such as utilizing a work flow analysis which incorporates the performance of the remote workers. Optionally, the performance of the remote workers is utilized in a critical path analysis. The performance of the remote workers is optionally used in project management. The performance of the remote workers is optionally used to determine if the remote workers are meeting predetermined performance goals.

Optionally, the performance of remote workers is used to determine which remote worker(s) may impact a project schedule due to inadequate performance.

The performance of remote workers is optionally used to determine if remote workers are meeting milestones. Optionally, the performance of remote workers is used to determine if production of the remote workers is adequate between milestones. Optionally, the performance of remote workers is used to determine if the production of the remote workers is adequate on a generally continuous basis.

According to one aspect of the present invention, a method for facilitating remote working comprises monitoring at least one parameter representative of performance of at least one remote worker and the parameter(s) are monitored at more than one time. The monitored parameter(s) for a given remote worker at a given time are each compared to a standard. The standard is determined from previously monitored parameter(s) for the same remote worker. The standard is optionally determined from an average of the monitored parameter(s) for the same remote worker.

According to one aspect of the present invention, a method for facilitating remote working comprises monitoring at least one parameter representative of performance, wherein the parameter is monitored for a plurality of remote workers. The monitored parameter(s) for a given remote worker are compared to a standard. The standard is determined from the monitored parameter of at least one other remote worker.

Optionally, the standard is determined from the monitored parameter(s) of a plurality of other remote workers. Optionally, the standard is an average of the monitored parameters of a plurality of other remote workers. Optionally, the standard is determined from at least one measured parameter and the parameter(s) are measured for each one of a group of remote workers.

According to one aspect of the present invention, a method for facilitating remote working comprises monitoring at least one parameter representative of performance wherein the parameter is suitable for defining an anomalous characteristic for the work being performed by the worker is determined.

The anomalous characteristic optionally comprises a deviation in the monitored parameter(s) over time for a given worker. The anomalous characteristic alternatively comprises a deviation in the monitored parameter(s) among a plurality of different remote workers. Thus, the present invention determines the performance of one or more remote workers by identifying deviations in the performance of a worker as compared to the worker's previous performance or the present invention identifies a deviation in at least one monitored parameter for a given worker, as compared to the performance of other workers.

According to another aspect of the present invention, a method for facilitating remote working comprises monitoring the computer activities of a plurality of remote workers and identifying a remote worker whose computer activities are substantially different from the computer activities of other workers. Optionally, a remote worker is identified when the remote worker's computer activities are different from the computer activities of other remote workers by more than a pre-determined amount.

Identifying a remote worker whose computer activities are different from the computer activities of other remote workers by more than a pre-determined amount optionally comprises statistically determining at least one parameter representative of the computer activities of the other workers. That is, statistical analysis is performed upon the computer activities of the other workers, so as to define a statistical quantity such as an average, a median, a mode or any other desired statistical value, which is then compared to the computer activities of the remote worker, so as to determine if the computer activities of the remote worker differs substantially from those of other remote workers.

Identifying a remote worker whose computer activities are different from the computer activities of other remote workers by more than a pre-determined amount optionally comprises algorithmically determining at least one parameter representative of the computer activities of other workers. That is, an algorithm, such as a computer algorithm, is used to determine if at least one parameter representative of the activities of a remote worker different from at least one parameter of the computer activities of other workers.

According to one aspect of the present invention, a method for facilitating remote working comprises monitoring at least one parameter representative of performance, the parameter being monitored for a plurality of remote workers, and determining if a deviation in a pre-defined pattern of the monitored parameter(s) occurs. The deviation indicates a difference in performance with respect to a performance standard. This difference may be associated with poor performance, superior performance, or neither.

According to one aspect of the present invention, a method for monitoring activities of remote workers comprises providing communication between a computer of a remote worker and a computer of a supervisor. Information representative of a monitor display of the computer of the remote worker is transmitted to a computer of the supervisor. Information representative of the transmitted monitor display is displayed upon a monitor of the supervisor. Displaying the transmitted information allows the supervisor to observe activities of the remote worker.

Optionally, transmitting information representative of a monitor display comprises transmitting information representative of the monitor display securely. Optionally, the information representative of the monitored display is encrypted prior to transmitting the information and the information representative of the monitor display is decrypted prior to displaying the information.

Preferably, the activities of the remote worker are observed without controlling the computer of the remote worker. Optionally, the remote worker is notified when a supervisor is observing the activities of the remote worker. However, the system and method of the present invention preferably also allows monitoring of the activities of the remote worker without the remote worker being notified that the remote worker's activities are being monitored.

Optionally, the displayed information representative of the transmitted monitor display is substantially identical to the monitor display of the remote worker. Alternatively, the displayed information representative of the transmitted monitor display is abstract as compared to the monitor display of the remote worker. For example, the displayed information representative of the transmitted monitor display is optionally a summary of at least a portion of the monitor display of the remote worker.

Referring now to FIG. 1, the system and method for facilitating the activities of workers of the present invention generally comprises at least one server, preferably a plurality of servers 10; at least one personal computer (PC), preferably a plurality of PCs 11; and a communication medium, such as a network 13. The network 13 is preferably the Internet, although, as those skilled in the art will appreciate, various networks including local area networks (LANs), wide area networks (WANs), virtual private networks (VPNs) and various other networks are likewise suitable.

The servers 10 preferably comprises a messaging server 10a, a multiplexing server 10b, and a reporting server 10c and logging server 10d. As those skilled in the art will appreciate, a plurality of messaging servers 10a, multiplexing servers 10b, reporting servers 10c and/or logging server 10d may be utilized.

According to the preferred embodiment of the present invention, at least one messaging server 10a, multiplexing server 10b, reporting server 10c, and logging server 10d are located at a common location. That is, a messaging server 10a, a multiplexing server 10b, a reporting server 10c and logging server 10d are located proximate one another for operational and maintenance convenience. The messaging server 10a, the multiplexing server 10b, the reporting server 10c and the logging server 10d may comprise a single computer, if desired.

The messaging server 10a comprises a messaging database 12. The messaging database 12 stores any desired messages, such as those communicated between the personal computers 11. The messaging database 12 optionally stores summary data such as a count of the number of messages between each pair of PCs 11, the length of such messages, and the time that these messages were communicated. The messaging database 12 optionally stores any desired statistical or operational data regarding messages sent among or between the personal computers 11.

The multiplexing server 10b receives communications from the personal computers 11, preferably via a secured channel. The multiplexing server 10b communicates these messages and/or information representative of these messages, such as statistical or operational information, to either the messaging server 10a, reporting server 10c, or logging server 10d. Generally, copies of the message will be sent to the messaging server 10a. Optionally, statistical and/or operational data regarding the message will be generated by the multiplexing server 10b and transmitted, such as along with the message, to the messaging server 10a. Alternatively, such statistical and/or operational data may be generated by the messaging server 10a. In any event, the message in any such statistical and/or operational data is stored in the messaging database 12. Operational data includes any desired information relating to any messages sent among any of the PCs and servers, such as routing information, message size, time spent, etc. Messages are stored in the messaging database 12 until they are required, such as by a request from one of the personal computers 11.

The logging server 10d keeps track of all of the monitored information that occurs while remote workers are using the system to work on tasks. This information is also undergoes anomaly detection 15. Anomaly detection 15 is a process for determining the performance of remote workers by comparing various parameters regarding their work performance to either the later parameters of other workers or to related parameters of the same worker at different times. Parameters, either alone or in any desired combination, are monitored so as to facilitate anomaly detection. For example, such parameters include time logged onto a computer, number of key strokes entered into a computer, time spent in a file, number of files opened, difference in file size as monitored at two different times, time spent in network activities, quantity of data transferred via a network, number of applications opened, number of documents open, and identity of current window focus, and/or time during which no activity is detected.

As those skilled in the art will appreciate, such parameters are indicative, although maybe not determinative, of the performance of a remote worker. For example, time logged onto a computer provides some indication of the amount of time that a remote worker spent working on the computer. In order to determine whether this or any other parameter is appropriate, the value of the parameter is compared either to the value of the same parameter of other workers or to historic values of the parameter for the same worker. In this manner, anomalies in the work habits or patterns of a particular remote worker can easily be detected. Although the detection of such anomalies may not, in itself, be determinative of the performance of the remote worker, the detection of such anomalies does indicate to a supervisor that the matter should be investigated further.

Anomalies detected by anomaly detection 15 are recorded in a task event database 16a. Preferably, the task event database 16a is mirrored to a second task event database 16b for enhanced reliability.

Reporting server 10c processes information to generate reports regarding the performance of remote workers. The reporting server 10c preferably comprises a report processor 20 which cooperates with data mining 21, so as to utilize information regarding the monitored parameters of remote workers in order to generate desired reports. Such reports are generated by the report processor 20 and stored and reporting database 22 for subsequent retrieval, such as by a supervisor.

The multiplexing server 10b facilitates communication between the plurality of personal computers 11, such as employee Microsoft personal computer 11a, employer Linux personal computer 11b and employee Macintosh computer 11c. Those skilled in the art will appreciate that the multiplexing server 10B can facilitate communication between any desired combination of personal computers, mini computers, main framed computers, laptop computers, notebook computers, wireless devices, personal digital assistance (PDAs), Internet enabled telephones, and any other desired networkable devices.

As mentioned above, such communications are preferably facilitated via secured channels. Such secured channels optionally comprise virtual private networks or the use of secure protocols. Such secure channels are preferably facilitated via the use of realtime data encryption.

Optionally, the messaging server 10a facilitates communication, preferably secured communication via direct channels between personal computers (such as between employee Microsoft personal computer 11a and employer Linux personal computer 11b.

In addition to determining the performance of remote workers, the system and method for facilitating the activities of remote workers also facilitates such remote working activities as communication between remote workers and/or supervisors, file sharing, teleconferencing, data sharing, text transfers between one remote worker and another remote worker, text transfers between a remote worker and non-remote worker, voice communication between one remote worker and another remote worker, voice communication between a remote worker and a non-remote worker, voice to text and text to voice communication between one or more remote workers with a voice capability and one or more workers with a text capability on their device, real time voice or text language translation, online chat between one remote worker and another remote worker, online chat between a remote worker and a non-remote worker, instant messaging between a remote worker and non-remote worker, file transfers between one remote worker and another remote worker, file transfers between a remote worker and a non-remote worker, collaborative work on a command document, collaborative work on multi documents, collaborative work on a commonly distributed application, collaborative work on separate applications, and collaborative work by providing means of communication between different clients or remote workers. Indeed, communications and collaboration between any desired combination of remote workers and non-remote workers is optionally facilitated by the present invention.

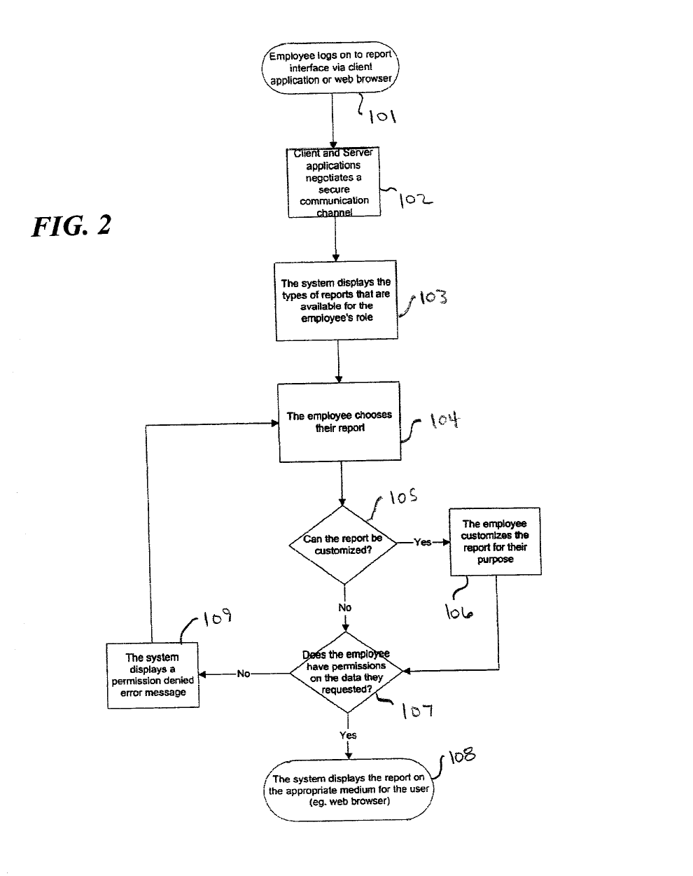

Referring now to FIG. 2, the process of displaying a report is shown. The process of displaying a report comprises the employee logging onto the report interface via a client application or web browser as shown in Block 101. Typically, the employee will log onto the report interface via one of the personal computers 11 of FIG. 1.

The client and server applications negotiate a secure communication channel as shown in Block 102. The secure channel will be negotiated between the personal computer 11 (such as employee Microsoft personal computer 11a, employer Linux personal computer 11b or employee Macintosh computer 11c) and the reporting server 10c.

The reporting server 10c effects the display of the types of reports that are available for the employee's role on the client personal computer 11, as shown in Block 103.

The employee chooses the desired report, as shown in Block 104, if the report can be customized, Block 105, then the employee customizes the report with the employee's particular purpose as shown in Block 106.

If the employee has permission to access the data that was requested, Block 107, then the system displays the report on the appropriate medium for the user, such as a web browser, as shown in Block 108.

If the report could not be customized, Block 105, then the employee is not permitted to customize the report, and a standard report must be accepted. Permission for the employee to access the data which the employee requested, Block 107, is required whether or not the report is customized. If the employee does not have permission to access the requested data, 107, then a permission denied error message is displayed, as shown in Block 109.

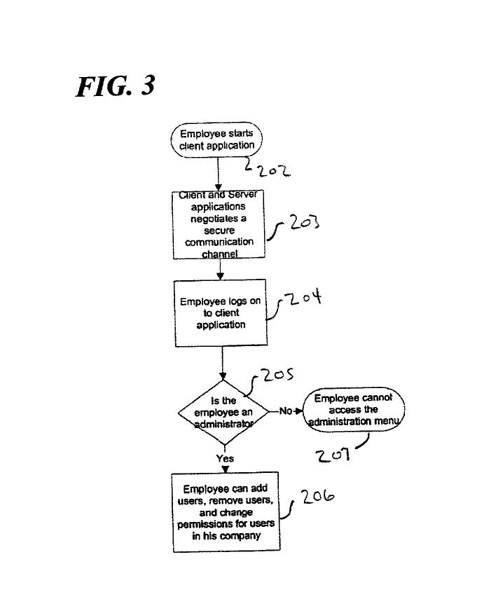

Referring now to FIG. 3, the process for adding users and changing permissions is shown. An employee starts a client application, as shown in Block 202. The client and server applications negotiate a secure communication channel between the employee and either the multiplexing server or the reporting server. The programs for adding users and changing permissions may either be located in the multiplexing server 10B or the reporting server 10C, as desired. Indeed, the adding user and changing permission software may be located in any other desired computer.

The employee logs on to the client application, as shown in Block 204.

If the employee is an administrator, Block 205, then the employee can add users, remove users, and change permissions for users in his company, as shown in Block 206. If the employee is not an administrator, 206, then the employee cannot access the administration menu, as shown in Block 207.

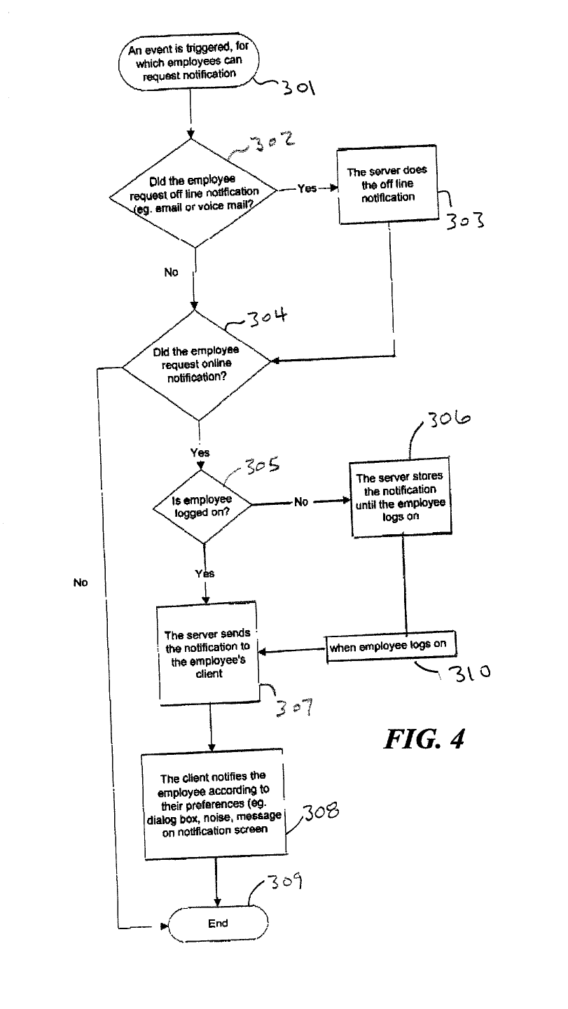

Referring now to FIG. 4, the process for automated notification is shown. The process for automated notification comprises the triggering of an event for which an employee requests notification, as shown in Block 301. Such events can comprise, for example, anomalies, as detected by anomaly detection 15 of FIG. 1. Various other events may be utilized to trigger employee notification, as well. For example, one employee may wish to be notified when another employee logs on to his computer, so that the two employees may collaborate on a desired project.

If the employee requested off line notification, Block 302 such as via e-mail or voicemail, then the server does the off line notification, as shown in Block 303.

If the employee did not request off line notification, Block 302, then a determination is made as to whether or not the employee requested on-line notification, as shown in Block 304. If the employee did request on line notification, Block 304, then a check is made to see if the employee is logged on, Block 305. If the employee did not request on line notification, Block 304, then the process ends, as shown in Block 309.

If the employee is logged on, Block 305, then the server sends the notification to the employee's client, as shown in Block 307. If the employee is not logged on, Block 305, then the server stores the notification until the employee logs on, Block 306. Then, when the employee logs on, Block 310, the server then sends the notification to the employee's client, Block 307.

The client notifies the employee according to their preference, such as via a dialog box, noise, a message or notification screen, or via any other desired means, as shown in Block 308. The process then ends, as shown in Block 309.

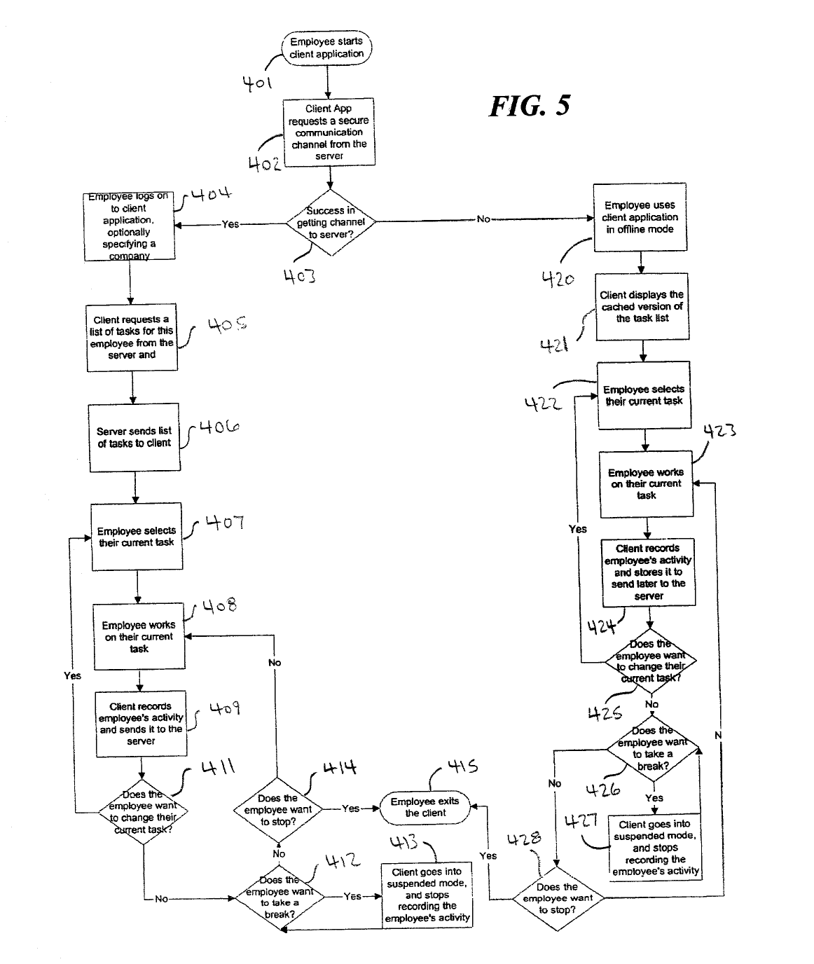

Referring now to FIG. 5, the process for an employee performing a task utilizing the system and the method for facilitating the activities of remote workers, according to the present invention are shown. The employee starts a client application, as shown in Block 401. The client application request a secure communication channel from the server, as shown in Block 402. If a secured channel communication between the client and the server is established, Block 403, then the employee logs on to the client application, as shown in Block 404. Optionally, the client specifies a company. The client may want to specify a company, for example, when the client is a consultant doing work for a plurality of different companies. In this instance, the client will specify which company the client intends to do work for at that time.

The client request a list of task for this employee from the server, as shown in Block 405. The serve sends a list of task to the client as shown in Block 406.

The employee selects a current task to be performed, as shown in Block 407. The employee then works on the current task as shown in Block 408. The client records the employees activity and sends information representative of the employee's activity to the server, as shown in Block 409. The information representative of the employee's activity may be the work product itself, such as a text document or a software program. Alternatively, the information representative of the employee's work product may comprise statistical or summary information, such as the application(s) utilized by the employee, the difference in file size between opening and closing of any data files by the employee the time spent working, etc.

The employee is provided with the option of changing the current task, 411. If the employee changes the current task, then the employee selects a new current task, as shown in Block 407. If the employee does not change the current task, the employee is may also take the option to take a break, as shown in Block 412. If the employee elects to take a break, then the client goes into a suspended mode of operation and stops recording the employee's activities, as shown in Block 413. The client resumes recording the employee's activities once the employee indicates that the break has ended.

If the employee does not elect to take a break, Block 412, then the employee has the option of stopping work, Block 414. If the employee does not want to stop, then the employee works on the current task, as shown in 408.

If the employee elects to stop work, Block 414, then the employee exits the client, as shown in Block 415.

If the client application was not successful in obtaining a channel to the server, Block 403, then the employee uses the client application in an offline mode, as shown in Block 420. The client displays the cached version of the task list, as shown in Block 421.

As before, the employee selects a current task to be worked upon, as shown in Block 422. The employee works on the current task, as shown in Block 423.

The client records the employee's activity and stores it so that a recorded employee's activity may later be sent to the server, as shown in Block 424.

If the employee wants to change the current task, 425, then the employee selects a new current task, as shown in Block 422. If the employee does not want to change the current task, 425, then employee is provided with the opportunity to take a break. If the employee elects to take a break, 426, then the client goes into a suspended mode and stops recording the employee's activity, as shown in Block 427.

If the employee does not elect to take a break, Block 426, then the employee is provided with the opportunity to stop working on the task, 428. If the employee does not want to stop working on the task, then the employee continues to work on the current task, as shown in Block 423. If the employee does want to stop working on the task, Block 428, then the employee exits the client, as shown in Block 415.

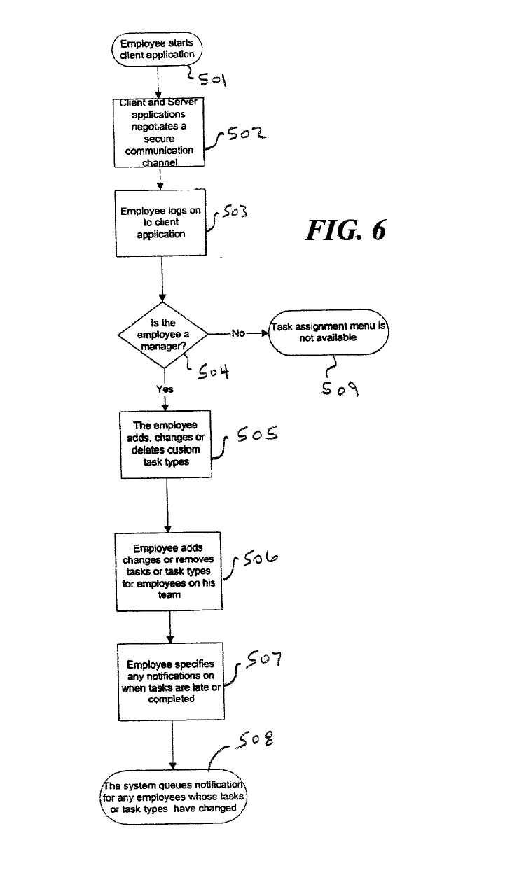

Referring now to FIG. 6, the process for assigning task and task types is shown. An employee starts a client application, as shown in Block 501. The client and server applications negotiate a secure communication channel, as shown in Block 502. The employee logs on to the client application as shown in Block 503.

If the employee is a manager, Block 504, then the employee adds to, changes or deletes from the list of custom task types, as shown in Block 505.

The employee adds to, changes or removes from task or task types for employees on his team, as shown on Block 506. In this manner, the employee, generally a supervisor, defines work which other employees under the supervisor's supervision are to perform.

The employee specifies any notifications on when task are late or completed, as shown in Block 507. That is, the supervisor defines the milestones associated with each particular task, where milestones are desired. When a milestone is not met, the system notifies the supervisor that the task has not been completed on time. If the task is completed at the appropriate time, then the supervisor is notified that the task has been completed on time. Optionally, the worker performing task is also notified when the task has not been completed on time and/or when the task has been completed on time.

The system queues notification for any employees whose task or task types have changed, as shown in Block 508. In this manner, employees are promptly notified on any changes to the work that they are expected to perform.

If the employee is not a manager, Block 504, then the task assignment menu is not available to that employee, as shown in Block 509.

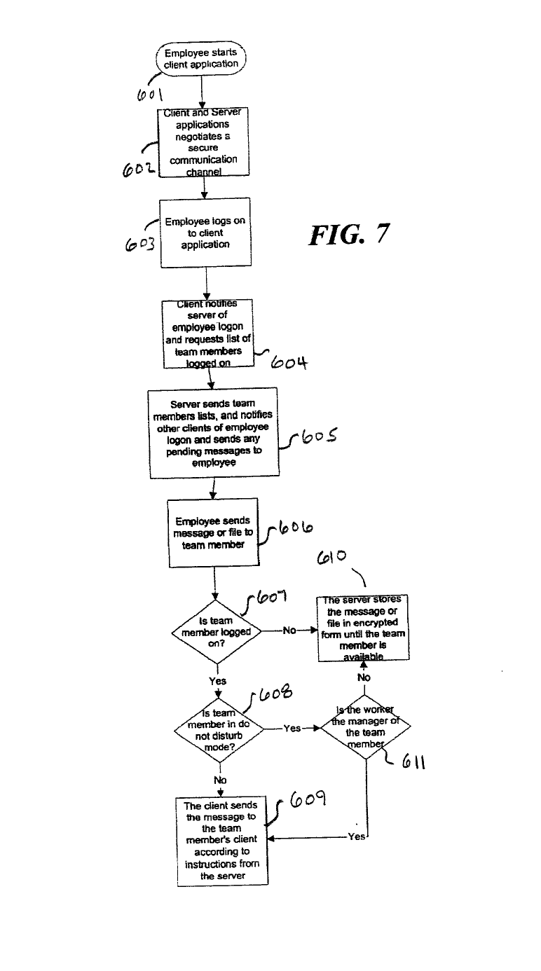

Referring now to FIG. 7, the process of communicating with team members is shown. An employee starts a client application, as shown in Block 601. The client and server applications negotiate a secure communication channel, as shown in Block 602. The employee logs on to the client application, as shown in Block 603.

The client notifies the server of employee log on and requests a list of team members who are also currently logged on, as shown in Block 604. This list may optionally include the company's lists of project team members, and other members who are selected by the worker (buddy list).

The server sends team members the list of other team members who are currently logged on and notifies other clients of employee log on and sends any pending messages to the employee, as shown in Block 605.

The employee has the opportunity to send messages or files to other team members, as shown in Block 606. If the employee attempts to send a message or file to another team member, Block 606, then the system verifies that the other team member is currently logged on, Block 607. If the other team members currently logged on, then the system checks to see if the other team member is operating in a do not disturb mode, Block 608. If the other team member is not currently operating and in a do not disturb mode, 608, then the client sends the message to the other team member's client according to the instructions received from the server, as shown in Block 609.

If the other team member was not logged on, Block 607, then the server stores the message or file in encrypted form until the other team member is available, as shown in Block 610.

If the other team member is operating in the do not disturb mode, then the system checks to see if the worker sending the message is a manager of the team member, Block 611. If the worker sending the message is a manager of the team member to whom the message is being sent, Block 61 1, then the client sends a message to the team member's client according to instructions from the server, as shown in Block 609. If the worker sending the message is not a manager of the team member to whom the message is to be sent, Block 611, then the server stores the message or file in encrypted form until the team member is available, as shown in Block 610.

The present invention provides a system and method for facilitating the activities of remote workers which includes the capability for accurately monitoring the performance of remote workers, so that employers are encourage to implement and utilize remote working programs.

It is understood that the exemplary system and method for facilitating the activities of remote workers described herein and shown in the drawings represents only a presently preferred embodiment of the invention. Indeed, various modifications and additions may be made to such embodiment without departing from the spirit and scope of the invention. For example, rather than utilizing discrete servers, the present invention may alternatively utilize distributed servers, wherein each computer functioning as a server also functions as a client for a remote worker, supervisor or other personnel in the manner of a peer-to-peer network configuration. Indeed, any desired combination of computers, personal display adapters (PDAs), cell phones, or any other desired devices capable of communicating with one another may be utilized. Thus, these and other modifications and additions may be obvious to those skilled in the art and may be implemented to adapt the present invention for use in a variety of different applications.

What is claimed is:

1. A method for facilitating remote working, the method comprising:
monitoring at least one parameter which is representative of performance of at least one remote worker; and
determining performance of the remote worker(s) at least partially by the monitored parameter(s).

2. The method as recited in claim 1, wherein:
monitoring at least one parameter comprises monitoring at least one parameter of at least one remote worker over time; and
determining performance of the remote worker(s) comprises comparing the monitored parameter(s) of the remote worker(s) for one time period to monitored parameter(s) of the same remote worker(s) for at least one other time period.

3. The method as recited in claim 1, wherein:
monitoring at least one parameter comprises monitoring at least one parameter of at least one remote worker over time; and
determining performance of the remote worker comprises comparing the monitored parameter of the remote worker for one time period to the monitored parameter of the same remote worker for at least one other time period.

4. The method as recited in claim 1, wherein:
monitoring at least one parameter comprises monitoring at least one parameter of at least one remote worker over time; and
determining performance of the remote worker(s) comprises comparing present monitored parameter(s) of the remote worker(s) to past monitored parameter(s) of the remote worker(s).

5. The method as recited in claim 1, wherein:
monitoring at least one parameter which is representative of performance of at least one remote worker comprises monitoring at least one parameter of a plurality of remote workers; and
determining performance of the remote worker(s) at least partially by comparing the monitored parameter(s) for one remote worker to the monitored parameter(s) for at least one other remote worker.

6. The method as recited in claim 1, wherein:
monitoring at least one parameter which is representative of performance of at least one remote worker comprises monitoring at least one parameter of a plurality of remote workers; and
determining performance of the remote worker(s) at least partially by the monitored parameter(s) comprises comparing the monitored parameter(s) for one remote worker to the monitored parameter(s) for a plurality of the other remote workers.

7. The method as recited in claim 1, wherein:
monitoring at least one parameter which is representative of performance of at least one remote worker comprises monitoring at least one parameter of a plurality of remote workers who are performing substantially the same task; and
determining performance of the remote worker(s) at least partially by the monitored parameter(s) comprises comparing the monitored parameter(s) for one remote worker to the monitored parameter(s) for at least one other remote worker.

8. The method as recited in claim 1, wherein:
monitoring at least one parameter comprises both monitoring at least one parameter of at least one remote worker over time and monitoring at least one parameter of a plurality of remote workers at the same time; and
determining performance of the remote worker(s) comprises both comparing the monitored parameter(s) to the monitored parameters for the same worker(s) over time and comparing the monitored parameter for one remote worker to the monitored parameter(s) for other remote workers.

9. The method as recited in claim 1, wherein the monitored parameter(s) comprises at least one monitored parameter selected from the group consisting of:
time logged onto a computer;
the identity of the task being worked on;
the project or end client for which the task is being done;
the time working on a task;
the type of task being worked on;
number of keystrokes entered into a computer;
the amount of mouse movement;
the number of mouse clicks;
the rate of keystrokes entered;
the rate of mouse movement;
the rate of mouse clicks;
time spent in a file;
number of files opened;
difference in file size as monitored at two different times;
time spent in network activities;
quantity of data transferred via a network;
time during which no activity is detected;
number and identity of applications opened;
number and identity of application windows opened;
time spent in each application window;
number of keystrokes entered while in an application window;
the amount of mouse movements while in an application window;
the number of mouse clicks while in an application window;
the rate of keystrokes entered while in an application window;
the rate of mouse movement while in an application window;
the rate of mouse clicks while in an application window;
number of documents opened; and
identity of current window focus.

10. The method as recited in claim 1, wherein determining the performance of the remote worker(s) comprises comparing the monitored parameter(s) to at least one predetermined standard.

11. The method as recited in claim 1, wherein determining the performance of the remote worker(s) comprises comparing the monitored parameter(s) to at least one average of parameter(s).

12. The method as recited in claim 1, wherein the monitored parameter is an average.

13. The method as recited in claim 1, wherein determining the performance of the remote worker(s) comprises comparing the monitored parameter(s) to at least one average of the monitored parameter(s) taken over time.

14. The method as recited in claim 1, wherein determining the performance of the remote worker(s) comprises comparing the monitored parameter(s) to at least one average of previous measurements of the parameter(s) taken among remote workers.

15. The method as recited in claim 1, wherein determining the performance of the remote worker(s) comprises comparing the monitored parameter(s) to at least one average of present measurements of the parameter(s) taken among remote workers.

16. The method as recited in claim 1, wherein monitoring at least one parameter which is representative of performance comprises monitoring at least one parameter that is representative of productivity.

17. The method as recited in claim 1, wherein the remote worker(s) are located a substantial distance from a supervisor of the remote worker(s).

18. The method as recited in claim 1, wherein the remote worker(s) are located a substantial distance from where determining performance of the remote worker(s) occurs.

19. The method as recited in claim 1, wherein the remote worker(s) are located near a supervisor of the remote worker(s).

20. The method as recited in claim 1, wherein the remote worker(s) are located near where determining performance of the remote worker(s) occurs.

21. The method as recited in claim 1, further comprising at least one act selected from the group of acts consisting of: p1 facilitating text transfer between two or more remote workers; facilitating text transfer between two or more remote and/or non-remote workers;
facilitating voice communication between two or more remote workers;;
facilitating voice communication between two or more remote and/or non-remote workers;
facilitating voice to text and text to voice communication between one or more remote or non-remote workers with a voice interface, and one or more remote or non-remote workers with a text interface;
facilitating text transfer including real time language translation between two or more remote and/or non-remote workers;
facilitating voice communications including real time language translation between two or more remote and/or non-remote workers
facilitating voice to text and text to voice communications between one or more remote and/or non-remote workers with a voice interface, and one or more remote and/or non-remote workers with a text interface;
facilitating online chat between two or more remote workers;
facilitating online chat between two or more remote and/or non-remote workers;
facilitating instant messaging between two or more remote workers;
facilitating instant messaging between two or more remote and/or non-remote workers;
facilitating file transfers between two or more remote workers;
facilitating file transfers between two or more remote and/or non-remote workers;
facilitating collaborative work on a command document;
facilitating collaborative work on multiple documents;
facilitating collaborative work on a commonly distributed application;
facilitating collaborative work on separate applications; and
facilitating collaborative work by providing means of communication between different clients.

22. The method as recited in claim 1, further comprising a remote worker permissioning monitoring of at least one parameter which is representative of performance of the same remote worker.

23. The method as recited in claim 1, further comprising a non-remote worker permissioning monitoring of at least one parameter which is representative of performance of the same non-remote worker.

24. The method as recited in claim 1, further comprising identifying bottlenecks in a work flow analysis using performance of remote workers in real time.

25. The method as recited in claim 1, further comprising identifying bottlenecks in a work flow analysis using performance of non-remote workers or a mix of remote and non-remote workers in real time.

26. The method as recited in claim 1, further comprising using performance of remote workers in a critical path analysis in real time.

27. The method as recited in claim 1, further comprising using performance of remote and non-remote workers in a critical path analysis in real time.

28. The method as recited in claim 1, further comprising using performance of remote workers in real time project management.

29. The method as recited in claim 1, further comprising using performance of remote or non-remote workers in real time project management.

30. The method as recited in claim 1, further comprising using performance of remote workers to determine which workers are meeting predetermined performance goals.

31. The method as recited in claim 1, further comprising using performance of remote or non-remote workers to determine which workers are meeting predetermined performance goals.

32. The method as recited in claim 1, further comprising using performance of remote workers to determine in real time which worker(s) may impact a project schedule due to inadequate performance.

33. The method as recited in claim 1, further comprising using performance of remote or non-remote workers to determine in real time which worker(s) may impact a project schedule due to inadequate performance.

34. The method as recited in claim 1, further comprising using performance of remote workers to determine in real time if remote workers are meeting milestones.

35. The method as recited in claim 1, further comprising using performance of remote or non-remote workers to determine in real time if workers are meeting milestones.

36. The method as recited in claim 1, further comprising using performance of remote workers to determine in real time if production of remote workers is adequate between milestones.

37. The method as recited in claim 1, further comprising using performance of remote or non-remote workers to determine in real time if production of workers is adequate between milestones.

38. The method as recited in claim 1, further comprising using performance of remote workers to determine in real time if production of remote workers is adequate on a generally continuous basis.

39. The method as recited in claim 1, further comprising using performance of remote or non-remote workers to determine in real time if production of workers is adequate on a generally continuous basis.

40. A method for facilitating remote working, the method comprising:
monitoring at least one parameter representative of performance for at least one remote or non-remote worker, the parameter(s) being monitored at more than one time; and
comparing the monitored parameter for a given worker at a given time to a standard, the standard being determined from previously monitored parameter(s) for the same worker.

41. The method as recited in claim 31, wherein the standard is determined from an average of the monitored parameter(s) for the same worker.

42. A method for facilitating remote working, the method comprising:
monitoring at least one parameter representative of performance, the parameter being monitored for a plurality of remote or non-remote workers; and
comparing the monitored parameter(s) for a given worker to a standard, the standard being determined from the monitored parameter of at least one other remote or non-remote worker.

43. The method as recited in claim 33, wherein the standard is determined from the monitored parameters of a plurality of other remote and/or non-workers.

44. The method as recited in claim 33, wherein the standard is an average of the monitored parameters of a plurality of other remote and/or non-workers.

45. The method as recited in claim 33, wherein the standard is determined from at least one measured parameter, the parameter(s) measured for each one of a group of remote and/or non-remote workers.

46. The method as recited in claim 33, wherein the standard is determined from at least one measured parameter, the parameter(s) being an average of parameters measured for each one of a group of remote and/or non-remote workers.

47. A method for facilitating remote working, the method comprising:
monitoring at least one parameter(s) representative of performance, the parameter being monitored for a plurality of remote and/or non-remote workers; and
determining if the monitored parameter defines an anomalous characteristic for the work being performed by the remote or non-remote worker.

48. The method as recited in claim 38, wherein the anomalous characteristic comprises a deviation in the monitored parameter(s) over time for a given worker.

49. The method as recited in claim 38, wherein the anomalous characteristic comprises a deviation in the monitored parameter(s) among a plurality of different remote workers.

50. A method for facilitating remote working, the method comprising:
monitoring computer activities of a plurality of remote and/or non-remote workers; and
identifying a worker whose computer activities are different from the computer activities of other workers by more than a pre-determined amount.

51. The method as recited in claim 41, wherein identifying a remote or non-remote worker whose computer activities are different from the computer activities of other workers by more than a pre-determined amount comprises statistically determining at least one parameter representative of the computer activities of the other workers.

52. The method as recited in claim 41, wherein identifying a remote or non-remote worker whose computer activities are different from the computer activities of other workers by more than a pre-determined amount comprises algorithmically determining at least one parameter representative of the computer activities of the other workers.

53. A method for facilitating remote working, the method comprising:
monitoring at least one parameter representative of performance, the parameter being monitored for a plurality of remote and/or non-remote workers; and
determining if a deviation in a pre-defined pattern of the monitored parameter(s) occurs, the deviation indicating a difference in performance with respect to a performance standard.

54. A method for monitoring activities of a remote worker, the method comprising:
providing communication between a computer of the remote worker and a computer of a supervisor;
transmitting information representative of a monitor display of the computer of the remote worker to a computer of the supervisor;
displaying information representative of the transmitted monitor display on a monitor of the supervisor; and
wherein displaying the transmitted information allows the supervisor to observe activities of the remote worker.

55. The method as recited in claim 45, wherein transmitting information representative of a monitor display comprises transmitting information representative of the monitor display securely.

56. The method as recited in claim 45, further comprising:
encrypting the information representative of the monitor display prior to transmitting the information; and
decrypting the information representative of the monitor display prior to displaying information.

57. The method as recited in claim 45, wherein activities of the remote worker are observed without controlling the computer of the remote worker.

58. The method as recited in claim 45, further comprising notifying the remote worker when a supervisor is observing activities of the remote worker.

59. The method as recited in claim 45, wherein the displayed information representative of the transmitted monitor display is substantially identical to the monitor display of the remote worker.

60. The method as recited in claim 45, wherein the displayed information representative of the transmitted monitor display is abstract as compared to the monitor display of the remote worker.

61. The method as recited in claim 45, wherein the displayed information representative of the transmitted monitor display is a summary of at least a portion of the monitor display of the remote worker.

62. The method as recited in claim 21, wherein the worker is able to collaborate with those members of the project teams, as determined by the manager of those project teams.

63. The method as recited in claim 21, wherein the worker is able to collaborate with members of his choosing.

64. The method as recited in claim 21, wherein the worker is able to collaborate with other workers using a secure channel, which may optionally use encryption.

65. The method as recited in claim 21, wherein the worker is able to change his on-line visibility to other workers.

66. The method as recited in claim 21, wherein the manager of the worker is able to see the worker on line, despite any changes the worker or the manager make to their on-line visibility regarding other workers.

67. The method as recited in claim 1, wherein the the activities of remote or non-remote workers are recorded and used for for timesheet and billing purposes.

68. A method for facilitating remote working, the method comprising of at least one of:
facilitating text transfer between two or more remote workers;
facilitating text transfer between two or more remote and/or non-remote workers;
facilitating voice communication between two or more remote workers;;
facilitating voice communication between two or more remote and/or non-remote workers;
facilitating voice to text and text to voice communication between one or more remote or non-remote workers with a voice interface, and one or more remote or non-remote workers with a text interface;
facilitating text transfer including real time language translation between two or more remote and/or non-remote workers;
facilitating voice communications including real time language translation between two or more remote and/or non-remote workers
facilitating voice to text and text to voice communications between one or more remote and/or non-remote workers with a voice interface, and one or more remote and/or non-remote workers with a text interface;
facilitating online chat between two or more remote workers;
facilitating online chat between two or more remote and/or non-remote workers;
facilitating instant messaging between two or more remote workers;
facilitating instant messaging between two or more remote and/or non-remote workers;
facilitating file transfers between two or more remote workers;
facilitating file transfers between two or more remote and/or non-remote workers;
facilitating collaborative work on a command document;
facilitating collaborative work on multiple documents;
facilitating collaborative work on a commonly distributed application;
facilitating collaborative work on separate applications; and
facilitating collaborative work by providing means of communication between different clients.

69. A method for facilitating remote working, the method comprising of at least one of:
Saving project related documents on line, where they can be accessed by a permissioned list of remote and/or non-remote workers as determined by the manager of the project;
Accessing project related documents where the remote or non-remote worker has permissions to view the document;
Accessing project related documents where the remote or non-remote worker has permission to edit or change the document;
Keeping the history of all versions of the documents through a project;
Accessing project related documents where the remote or non-remote worker has permission to view the version history of a document;

70. The method as recited in claim 1, further comprising at least one act selected from the group of acts consisting of:
Saving project related documents on line, where they can be accessed by a permissioned list of remote and/or non-remote workers as determined by the manager of the project;
Accessing project related documents where the remote or non-remote worker has permissions to view the document;
Accessing project related documents where the remote or non-remote worker has permission to edit or change the document;
Keeping the history of all versions of the documents through a project;
Accessing project related documents where the remote or non-remote worker has permission to view the version history of a document;
